(19) United States
(12) Patent Application Publication
(10) Pub. No.: US 2010/0142889 A1
(43) Pub. Date: Jun. 10, 2010

(54) WAVELENGTH TUNABLE OPTICAL INTERLEAVER

(75) Inventors: Oh-Kee KWON, Daejeon (KR); Yongsoon BAEK, Daejeon (KR); Chul-Wook LEE, Daejeon (KR); Dong-Hun LEE, Daejeon (KR); Jong-Hoi KIM, Daejeon (KR); Eundeok SIM, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/544,196

(22) Filed: Aug. 19, 2009

(30) Foreign Application Priority Data
Dec. 8, 2008 (KR) 10-2008-0123915

(51) Int. Cl. G02B 6/28; G02B 6/26; G02B 6/42

(52) U.S. Cl. 385/24; 385/42; 385/31

(57) ABSTRACT

An optical interleaver of a wavelength division multiplexing (WDM) system includes an optical coupler, first and second waveguides, a high reflection mirror, and first and second phase shifters. The coupler divides an input optical signal. The first waveguide branches off from the coupler in a first direction. The second waveguide branches off from the coupler in a second direction for providing an optical path different from that provided by the first waveguide. The high reflection mirror is disposed at an end of the first waveguide for reflecting a first optical signal incident onto the first waveguide. The first phase shifter is disposed at an end of the second waveguide for multiple-reflecting a second optical signal incident onto the second waveguide. The second phase shifter is disposed at the first or second waveguide for adjusting an optical path difference between the first and second waveguides by varying its refractive index.

### CROSS-REFERENCE TO RELATED APPLICATIONS

This U.S. non-provisional patent application claims priority under 35 U.S.C. § 119 of Korean Patent Application No. 10-2008-0123915, filed on Dec. 8, 2008, the entire contents of which are hereby incorporated by reference.

### BACKGROUND OF THE INVENTION

The present invention disclosed herein relates to an optical communication device, and more particularly, to an optical interleaver configured by combining a Michelson interferometer (MI) and a Gires-Tournois (GT) mirror.

Much research is being conducted on fiber to the home (FTTH) technology to connect a telephone company to the home through an optical fiber for enabling transmission of large amounts of data in our high-speed internet and multimedia service environments. Although various optical systems have been studied to realize FTTH technology, the development of cost-down methods that do not affect data transmission capacity is still needed to commercialize such optical systems.

### SUMMARY OF THE INVENTION

The present invention provides a small, highly-reliable optical interleaver having a planar lightwave circuit (PLC) structure.

The present invention also provides a highly-reliable optical interleaver capable of wavelength tuning without mechanical adjustment.

Embodiments of the present invention provide optical interleavers including: an optical coupler configured to divide an input optical signal; a first waveguide branching off and extending from the optical coupler in a first direction; a second waveguide branching off from the optical coupler in a second direction for providing an optical path different from an optical path provided by the first waveguide; a high reflection mirror disposed at an end of the first waveguide for reflecting a first optical signal incident onto the first waveguide; a first phase shifter disposed at an end of the second waveguide for multiple reflection of a second optical signal incident onto the second waveguide; and a second phase shifter disposed at the first waveguide or the second waveguide for adjusting an optical path difference between the first and second waveguides by varying a refractive index of the second phase shifter.

In some embodiments, the first phase shifter may include: a first reflection surface configured to transmit or reflect the second optical signal separated from the input optical signal; a second reflection surface configured to reflect the second optical signal reflected by the first reflection surface; and a refractive index variable medium disposed between the first and second reflection surfaces.

In other embodiments, the optical interleaver may further include: a third waveguide configured to transmit the input optical signal to the optical coupler and output a first demultiplexer signal separated by the optical coupler in a demultiplexer mode; and a fourth waveguide configured to output a second demultiplexer signal separated by the optical coupler in the demultiplexer mode.

In still other embodiments, the optical interleaver may further include: a fifth waveguide connected to the third waveguide for receiving the input optical signal in the demultiplexer mode and outputting the third multiplexer signal in the multiplexer mode; and a sixth waveguide connected to the third waveguide for outputting the first demultiplexer signal in the demultiplexer mode and transmitting the first multiplexer signal to the third waveguide in the multiplexer mode. In addition, the optical interleaver may further include an optical amplifier disposed at the sixth waveguide for amplifying the first multiplexer signal or the first demultiplexer signal. In addition, the optical interleaver may further include an optical attenuator disposed at the fourth waveguide for attenuating the second multiplexer signal or the second demultiplexer signal.

In even other embodiments, the high reflection mirror may be a CBG (chirped Bragg grating) disposed at the end of the first waveguide.

In yet other embodiments, the first phase shifter may be a DGTE (dispersion Gires-Tournois etalon) in which CBGs are overlapped with each other.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a block diagram illustrating a mux/demux structure according to an embodiment of the present invention;

FIG. 2 is a plan view illustrating an optical interleaver according to a first embodiment of the present invention;

FIG. 3 is a plan view illustrating a modified version of the first embodiment of FIG. 2;

FIG. 4 is a plan view illustrating an optical interleaver according to a second embodiment of the present invention;

FIG. 5 is a plan view illustrating an optical interleaver according to a third embodiment of the present invention;

FIG. 6 is a sectional view illustrating a chirped Bragg grating (CBG) structure of FIG. 5 according to an embodiment of the present invention;

FIG. 7 is a section view illustrating a second phase shifter of FIG. 5 according to an embodiment of the present invention;

FIG. 8 is a graph showing transmission characteristics of an optical interleaver according to an embodiment of the present invention;

FIG. 9 is a graph showing center wavelength variations of an optical interleaver for different refractive index variations of the optical interleaver according to an embodiment of the present invention; and

FIG. 10 is a graph showing dispersion characteristics of an optical interleaver for different refractive index variations of the optical interleaver according to an embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

In the specification, the dimensions of layers and regions are exaggerated for clarity of illustration. It will also be understood that when a layer (or film) is referred to as being ‘on’ another layer or substrate, it can be directly on the other layer or substrate, or intervening layers may also be present. Also, though terms like a first, a second, and a third are used to describe various regions and layers in various embodiments of the present invention, the regions and the layers are not limited to these terms. These terms are used only to tell one region or layer from another region or layer. Therefore, a layer referred to as a first layer in one embodiment can be referred to as a second layer in another embodiment. An embodiment described and exemplified herein includes a complementary embodiment thereof.

In the present disclosure, although the term “optical interleaver” is used to explain an optical device, the optical interleaver may also be operated as an optical de-interleaver according to operation modes or disposed positions. That is, in the present disclosure, an optical device that can be operated as an optical interleaver or an optical de-interleaver according to operation modes or disposed positions is denoted by the term “optical interleaver”.

In a wavelength division multiplexing (WDM) system, optical signals propagating through an optical fiber should be independently handled according to wavelengths of the optical signals based on the grid standard of the international telecommunication Union (ITU). Therefore, optical components having different functions should be provided for a transmission terminal, a link, and a receiving terminal. For example, a transmission terminal may be provided with optical components such as a tunable laser, a multi-wavelength laser, and a multiplexer. A link may be provided with optical components such as an add/drop module and an optical cross-connect. A receiving terminal may be provided with optical components such as a demultiplexer and a photodetector.

To cope with current technical trends from dense WDM (DWDM) to ultra WDM (UWDM), optical components having improved performance are necessary. In a WDM system, an optical fiber can carry 64 channels normally and 160 channels maximally. Before long, the maximal capacity of an optical fiber may be increased to 320 channels. This will now be described in more detail together with related optical components. The channel spacing of a 2.5-Gbps WDM system (OC48) is required to be narrowed at about 25 GHz (λ=0.2 nm) or 12.5 GHz (λ=0.1 nm). For this, an optical source having frequency stability equal to or lower than 2 GHz is required, and an optical filter having a flat-top spectrum having 0.1-dB or lower ripples in a given channel spacing is required.

In addition, an optical component of which wavelength characteristics can be varied (tuned) in a given channel spacing is required. Furthermore, a 10-Gbps WDM system (OC192) may additionally need an optical component and a dispersion compensation module for 50-GHz (Δλ=0.4 nm) channel spacing, and a polarization mode dispersion (PMD) compensation module. Particularly, a PMD compensation module is an essential component of a 40-Gbps system.

Therefore, a device capable of supporting at least 25-Gbps channel spacing is necessary to provide a multiplexing/demultiplexing (muxing/demuxing) function for managing wavelengths of transmission and receiving terminals and a link of a WDM system under the above-described conditions. Up to now, multiplexer/demultiplexers (mux/demux) and band-pass filters have been configured based on micro-optics and planar lightwave circuit (PLC) technology, and current commercial products thereof have good characteristics for 100-GHz channel spacing. However, in 50-GHz or lower channel spacing conditions, a Fabry-Perot (F-P) filter (a representative micro-optics type demuxer) has high loss and limited precision. That is, a micro-optics type demuxer does not satisfy uniform spectrum and wavelength spacing grid accuracy requirements.

Furthermore, an arrayed waveguide grating (AWG) having a PLC structure does not also satisfy required specifications because the crosstalk level of the AWG increases with its size. Particularly, in the above-described structure, about 3-dB loss is additionally resulted for obtaining a desired pass-band flatness level. Therefore, it is difficult to support 50-GHz or lower channel spacing by using current AWG technology.

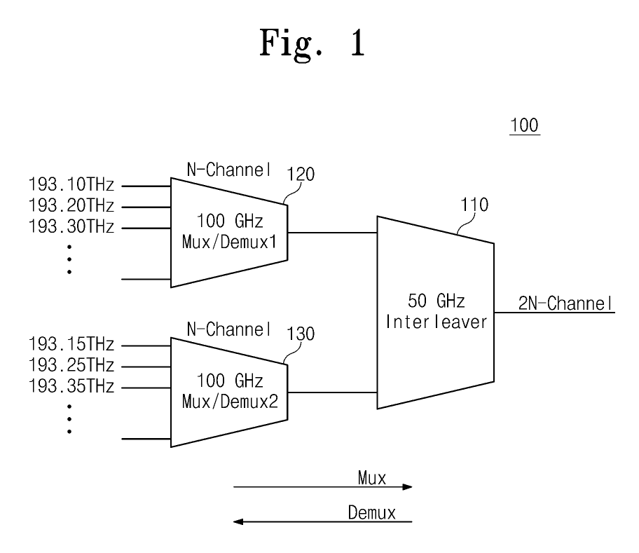

FIG. 1 is a block diagram illustrating a mux/demux structure of a WDM system according to an embodiment of the present invention. Referring to FIG. 1, a mux/demux 100 of the current embodiment includes an optical interleaver 110 configured to overcome typical technical limitations. As shown in FIG. 1, a 2N-channel optical mux/demux (the mux/demux 100) can be configured by an N-channel mux/demux1 120 having 100-GHz channel spacing, an N-channel mux/demux2 130 having 100-GHz channel spacing, and the optical interleaver 110 having 50-GHz channel spacing.

Each of the N-channel mux/demux1 120 and the N-channel mux/demux2 130 has an even or odd number of channels. The 2-N channel optical interleaver 110 is a flat-top comb filter having periodic characteristics in a wavelength or frequency region. The 2-N channel optical interleaver 110 has a flat-top comb filter structure so that the 2-N channel optical interleaver 110 can function as a periodic band pass filter.

The optical interleaver 110 is configured based on a lightwave interference phenomenon by combining a finite impulse response (FIR) filter structure (such as a Michelson interferometer (MI), a Mach-Zehnder interferometer, and a Sagnac interferometer) with an infinite impulse response (IIR) filter structure (such as a multi-cavity etalon and a ring resonator). Various optical interleavers have been studied and proposed based on bulk-optics, optical fibers, and PLCs. However, a bulk-optics interleaver is large, unreliable, and expensive because its input/output ports and other parts require precise alignment. In addition, the bulk-optics interleaver is not securely coupled to a PLC-structure AWG that is generally used as a mux/demux.

Furthermore, since controllers tune wavelengths by using mechanical displacements and foreign material insertion, the controllers are not durable and have high insertion loss. Optical fiber interleavers are relatively smaller than bulk-optics interleavers; however, optical fiber interleavers are still larger than PLC interleavers. In addition, an optical fiber interleaver should be additionally coupled to a PLC device such as an AWG and variable optical attenuator (VOA).

However, according to the present invention, the optical interleaver 110 can be easily coupled to an existing mux/demux and has low-loss, inexpensive, and highly-reliable characteristics. When the above-described mux/demux 100 is operated as a demux, the optical interleaver 110 functions as a De-interleaver. Even for this case, however, the term “interleaver” will be still used for the optical interleaver 110 for simplicity reason only. A 4N-channel mux/demux having 25-GHz channel spacing may be easily constituted by combining two 2N-channel mux/demuxes having 50-GHz channel spacing (such as the above-described mux/demux 100) with an optical interleaver having 25-GHz channel spacing.

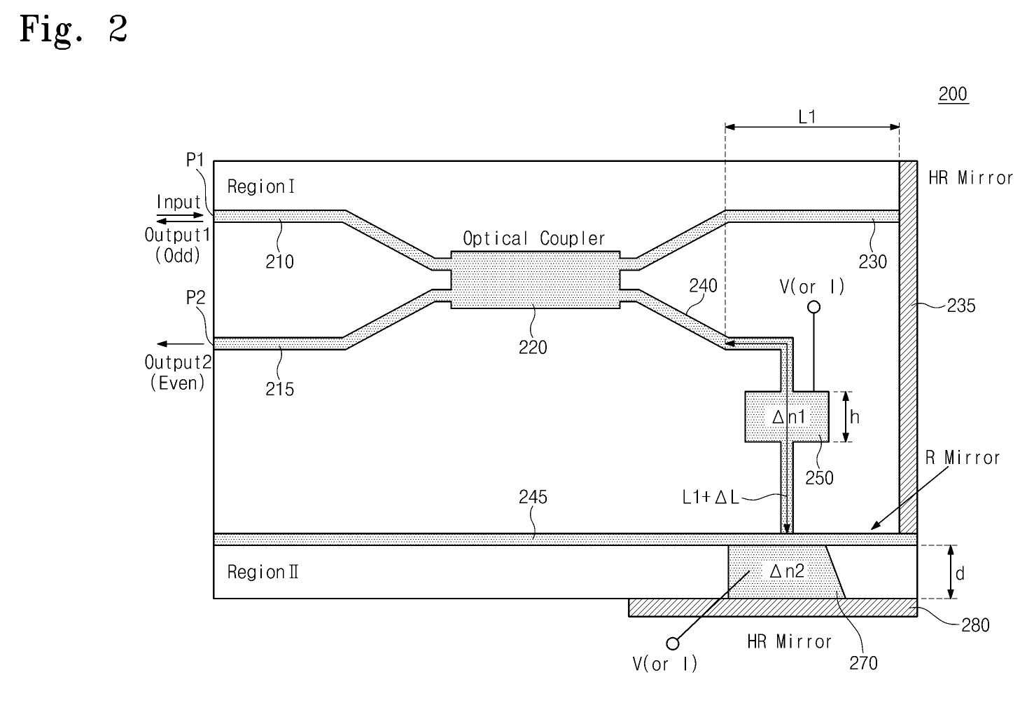

FIG. 2 is a schematic plan view illustrating an optical interleaver 200 according to a first embodiment of the present invention. Referring to FIG. 2, the optical interleaver 200 of the current embodiment can be formed in a PLC structure while satisfying requirements of a high-speed WDM-PON system.

The optical interleaver 200 includes a waveguide 210 configured to guide an input optical signal to an optical coupler 220, and a waveguide 215 configured to guide an even mode optical signal from the optical coupler 220 to a second port P2. The waveguide 210 is also used as an output optical path for transmitting an odd mode optical signal from the optical coupler 220 to a first port P1. The optical interleaver 200 further includes the optical coupler 220 and a waveguide 230 extending from the optical coupler 220 in a right direction to a high reflection mirror 235 to provide an optical path L1. In addition, an optical path (L1+ΔL) is formed by another optical path (waveguide) 240 extending from the optical coupler 220 and a reflection surface 245, so as to provide the function of a Michelson interferometer (MI). In addition, a first phase shifter 250 controls lightwave interference between the waveguide 240 and the reflection surface 245, and a second phase shifter 270 is disposed in a region (indicated by a distance (d)) between the reflection surface 245 and a high reflection mirror 280.

The high reflection mirrors 235 and 280 may be configured by mirror devices, or metal or dielectric thin-film coating surfaces that have a high reflective index of almost 100%. Each of the waveguides 210, 215, 230, and 240 may be formed of silica, a polymer, or a compound semiconductor such as InGaAsP/InP. The reflection surface 245 has a reflective index R and is used as a boundary between regions I and II. The regions I and II may be formed of different materials or the same material. In the current embodiment, a method of forming the reflection surface 245 is not limited to a particular method.

In the case where the regions I and II are formed of different materials, the optical interleaver 200 is fabricated by hybrid integration, and thus the reflection surface 245 can be formed using various materials and processes. In the case where the regions I and II are formed of the same material, the reflection surface 245 may be formed by etching a predetermined region and inserting a mirror having a predetermined reflective index into the etched region, or forming a photonic crystal pattern on a boundary surface between the regions I and II. In the optical interleaver 200 of the current embodiment, since the reflective index of the reflection surface 245 is not relatively high, the reflection surface 245 can be provided in the form of a Fresnel reflection structure formed by a mismatched width of the waveguide 240, instead of forming the reflection surface 245 by etching.

The high reflection mirrors 235 and 280 have almost 100% reflective indexes. The high reflection mirrors 235 and 280 may be formed of silica and/or a compound semiconductor such as InGaAsP/InP. In this case, the high reflection mirrors 235 and 280 may be formed by depositing dielectric thin films or a dielectric thin material on surfaces. In the case where the high reflection mirrors 235 and 280 are formed of a polymer, the high reflection mirrors 235 and 280 may be formed by deposition or thin-film attachment.

The first phase shifter 250 is disposed at the waveguide 240 of the region I. The first phase shifter 250 is formed of a material having a variable refractive index. The first phase shifter 250 defines a length (h) at the waveguide 240. The refractive index of the first phase shifter 250 is varied by Δn1 in response to an electric field (caused by a voltage or current applied to the first phase shifter 250). By this refractive index variation Δn1, the first phase shifter 250 functions as an optical path different controller (ΔL controller) to generate an optical path difference of the Michelson interferometer (MI). That is, due to the refractive index variation Δn1, the velocity of an optical signal passing through the first phase shifter 250 may be increased or decreased. If the refractive index of the first phase shifter 250 is increased, the velocity of an optical signal passing through the first phase shifter 250 is decreased, and thus the optical path difference ΔL is increased (elongated). On the other hand, if the refractive index of the first phase shifter 250 is decreased, the velocity of an optical signal passing through the first phase shifter 250 is increased, and thus the optical path difference ΔL is decreased (shortened). Therefore, an interference pattern of reflection light at the optical coupler 220 can be varied by the refractive index variation Δn1 of the first phase shifter 250.

The second phase shifter 270 is disposed between the reflection surface 245 and the high reflection mirror 280 to define the distance (d) in the region II, and the second phase shifter 270 is formed of a material having a variable refractive index. In response to an electric field (caused by a voltage or current applied to the second phase shifter 270), the refractive index of the second phase shifter 270 is varied by Δn2 for an optical signal passing through the reflection surface 245. Owing to this refractive index variation Δn2 of the second phase shifter 270, an additional optical path difference can be obtained. That is, the reflection surface 245 and the high reflection mirror 280 are provided to form an additional phase shifter (the second phase shifter 270). The second phase shifter 270 may be formed by inserting a refractive index variable material between the reflection surface 245 and the high reflection mirror 280 that have different refractive indexes, so that the reflection surface 245, the second phase shifter 270, and the high reflection mirror 280 can function as a Gires-Tournois (GT) mirror. That is, the reflection surface 245, the second phase shifter 270, and the high reflection mirror 280 can form a structure similar or equal to the structure of a GT mirror in which an air gap (d) or an ultra low emission (ULE) etalon gap (d) is formed between reflection films having different reflection indexes. Therefore, light incident through the waveguide 240 onto the reflection surface 245, the second phase shifter 270, and the high reflection mirror 280 can be multiple-reflected. This multiple reflection of incident light causes periodic nonlinear phase changes in a waveguide region. Thus, an interference pattern of reflection light at the optical coupler 220 can be varied.

The interference period of reflection light at the optical coupler 220, and the phase change period at the second phase shifter 270 are dependent on the optical path difference ΔL and the distance (d) between the reflection surface 245 and the high reflection mirror 280, respectively. That is, periodic characteristics of a flat-top band pass filter can be obtained at the optical coupler 220 by varying the refractive indexes of reflection surfaces without having to move the reflection surfaces mechanically.

In addition, according to the current embodiment, the center wavelength of the optical interleaver 200 can be finely adjusted. It can be assumed that an optical path difference 2ΔL varied by the first phase shifter 250 is related with the distance (d) of the second phase shifter 270 as shown in Equation 1 below.

d=2ΔL [Equation 1]

The relationship expressed by Equation 1 can be attained by controlling the refractive index variation Δn1 of the first phase shifter 250. Then, the center waveguide of the optical interleaver 200 can be finely moved by controlling the refractive index variation Δn2 of the second phase shifter 270. In this way, wavelength variation (wavelength tuning) can be realized. Since wavelength tuning can be realized without mechanical movement, highly reliable wavelength tuning is possible.

Various methods can be used to vary the refractive indexes of the first and second phase shifters 250 and 270 by applying electric fields to the first and second phase shifters 250 and 270. In the case where a phase shifter is formed of silica and a polymer, the refractive index of a medium can be varied by generating heat through metal parts disposed on upper and lower sides of a waveguide. In addition, a thermo-electric cooler (TEC) can be inserted into a region to be cooled. In the case of a compound semiconductor structure such as an InGaAsP/InP P-i-N structure, the refractive index of a medium can be varied by applying a current to a predetermined region. In the case of varying a refractive index by varying temperature, the refractive index of silica varies at a rate of about 0.8×10⁻⁵/□, and the refractive index of a polymer varies at a rate of about −2.5×10⁻⁴/□. In the case of applying a current to an InGaAsP (compound semiconductor) structure, a refractive index can be varied at a rate of about −5×10⁻²/□ maximally although the variation rate is varied according to a material of a waveguide core. That is, when temperature increases, the refractive index of silica increases but the refractive indexes of polymer and InGaAsP reduce.

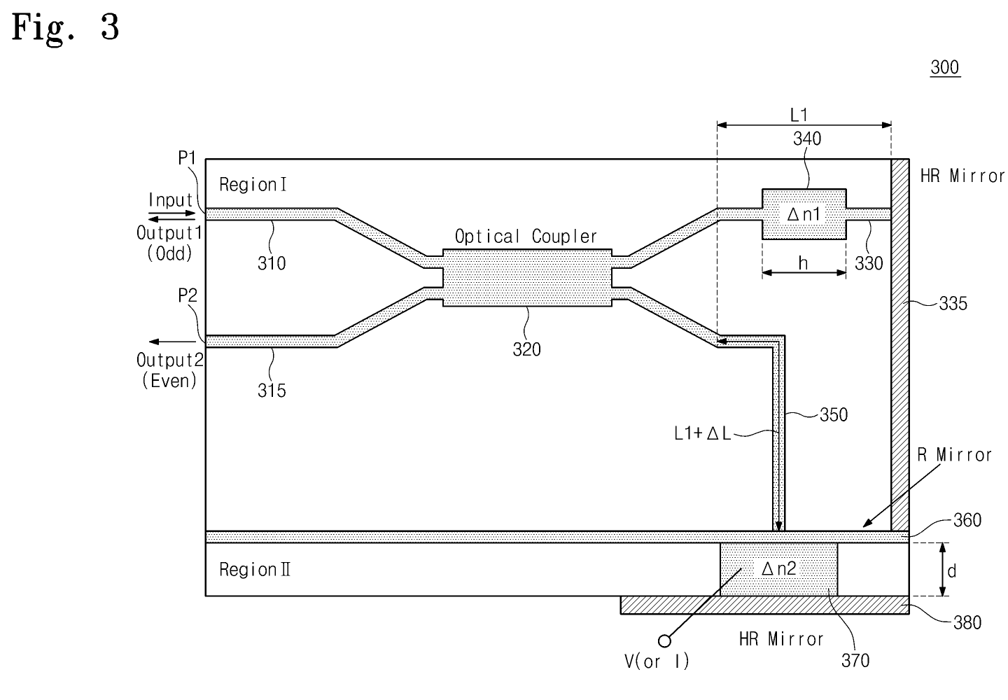

The second phase shifter 270 may be formed in the region II in a multi-layer GT mirror structure so as to improve the characteristics of the optical interleaver 200. In addition, the high reflection mirror 235 of the region I can also be formed in a GT mirror structure. In the structure shown in FIG. 3, one input port and two output ports (output 1 and output 2) indicate the case where the optical interleaver 200 is operated as a demux. If the input and output ports are reversed, it indicates that the reciprocal optical interleaver 200 is operated as a mux. Until now, explanations have been given on the optical interleaver 200 having a PLC structure that can be formed in one chip according to an embodiment of the present invention.

FIG. 3 is a plan view illustrating an optical interleaver 300 which is modified from the optical interleaver 200 of FIG. 2. Referring to FIG. 3, unlike the embodiment of FIG. 2, a first phase shifter 340 is disposed at a waveguide 330 forming an optical path L1. The position of the first phase shifter 340 is largely dependent on a method of generating a refractive index variation Δn1. As described above, in the case where the first phase shifter 340 is formed of silica and a polymer, the refractive index of a medium can be varied by generating heat through metal parts disposed on upper and lower sides of a waveguide. In addition, a TEC can be inserted into a region to be cooled. In the case of a compound semiconductor structure such as an InGaAsP/InP P-i-N structure, the refractive index of a medium can be varied by applying a current to a predetermined region. As described in FIG. 2, when temperature increases, the refractive index of silica is increased but the refractive indexes of a polymer and a compound semiconductor such as InGaAsP are reduced. Therefore, according to a material used for forming the first phase shifter 340, the first phase shifter 340 may be disposed at the waveguide 330 forming the optical path L1 at the right of an optical coupler 320. However, the position of the first phase shifter 340 is not limited thereto. That is, the first phase shifter 340 can be disposed at any position as long as an optical path difference can be varied.

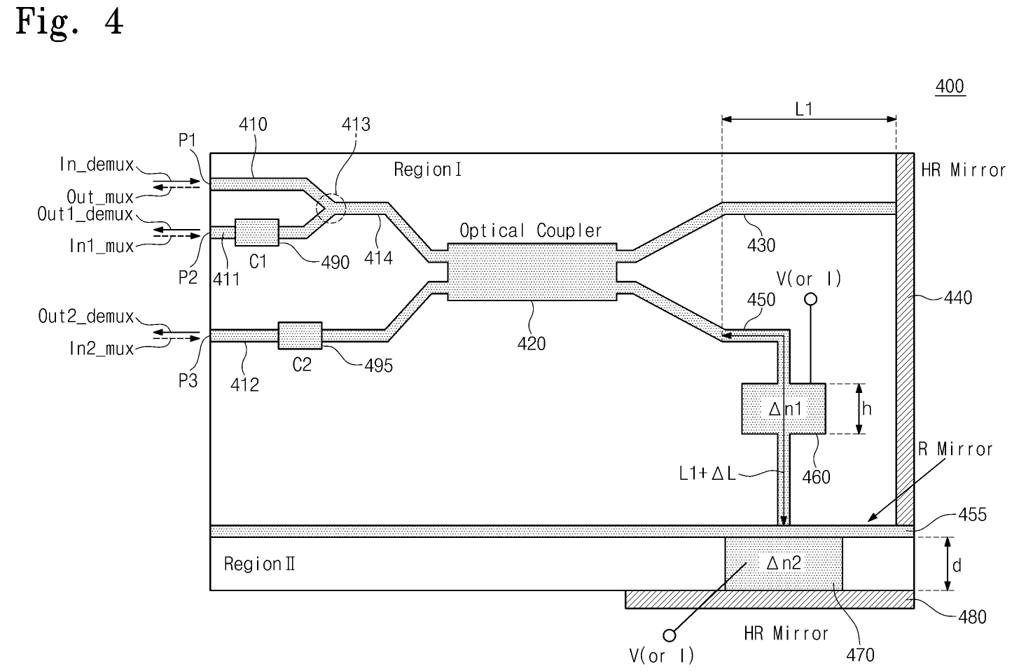

FIG. 4 is a view illustrating an optical interleaver 400 according to a second embodiment of the present invention. According to the second embodiment, a mux or demux can be easily realized by the optical interleaver 400 schematically shown in FIG. 4.

It may be necessary to insert a circulator into a front portion of the port P1 of the optical interleaver 200 of FIG. 2 or the optical interleaver 300 of FIG. 3, so as to use the optical interleaver 200 or the optical interleaver 300 as a mux/demux. That is, a circulator may be inserted to use the port P1 as an input port for receiving an input signal in the optical interleaver 300 and as an output port 1 for outputting an odd mode output signal. In this case, however, the circulator has to be oriented in different directions in mux and demux modes, and thus the reciprocity of an optical path between the mux and demux modes is not attained. To solve this limitation, the optical interleaver 400 of the second embodiment is provided as shown in FIG. 4. Referring to FIG. 4, the optical interleaver 400 has a mux/demux function and may be fabricated by a single integration method.

When the optical interleaver 400 operates in demux mode, an input optical signal In_demux is incident onto the port P1. Then, the input optical signal In_demux propagates to an optical coupler 420 through a waveguide 410 and a branch 413. Thereafter, the input optical signal In_demux is divided by de-interleaving into an even mode optical signal and an odd mode optical signal by the optical coupler 420, first and second phase shifters 460 and 470, and high reflection mirrors 440 and 480. In detail, an optical signal separated from the input optical signal In_demux by the optical coupler 420 and incident onto a waveguide 430 is reflected by the high reflection mirror 440 back to the optical coupler 420. That is, the optical signal incident onto the waveguide 430 from the optical coupler 420 propagates along an optical path 2L1. In addition, an optical signal separated from the input optical signal In_demux by the optical coupler 420 and incident onto a waveguide 450 is propagated along an optical path 2(L1+ΔL) through the first and second phase shifters 460 and 470 and is then returned to the optical coupler 420.

The optical signals reflected back to the optical coupler 420 with an optical path difference 2ΔL are brought into interference with each other and output as an even mode optical signal and an odd mode optical signal from the optical coupler 420 (de-interleaving). The odd mode optical signal is transmitted to a waveguide 414 and is output to a port P2 through an optical amplifier 490 as a first demux output Out1_demux of the optical interleaver 400. Then, the first demux output Out1_demux is transmitted to an odd mode demux such as the N-channel optical mux/demux2 130 of FIG. 1. The even mode optical signal is transmitted to a waveguide 412 and is output to a port P3 through an optical attenuator 495 as a second demux output Out2_demux of the optical interleaver 400. Then, the second demux output Out2_demux is transmitted to an even mode demux such as the N-channel optical mux/demux1 120 of FIG. 1.

When the optical interleaver 400 operates in mux mode, a first mux input In1_mux and a second mux input In2_mux are input from an odd mode mux such as the N-channel optical mux/demux2 130 of FIG. 1 and an even mode mux such as the N-channel mux/demux1 120 of FIG. 1 to the optical interleaver 400. The first mux input In1_mux of the odd mode mux (the N-channel optical mux/demux2 130) is incident onto the port P2 and is transmitted to the optical amplifier 490 through a waveguide 411. The second mux input In2_mux of the even mode mux (the N-channel mux/demux1 120) is incident onto the port P3 and is transmitted to the optical attenuator 495 through the waveguide 412. Then, the two optical signals (the first and second mux inputs In1_mux and In2_mux) are transmitted to the optical coupler 420 and are interleaved by the optical coupler 420, the first and second phase shifters 460 and 470, and the high reflection mirrors 440 and 480. Then, the interleaved optical signals (coupled even and odd mode optical signals) may be output through the port P1. In mux mode, the optical interleaver 400 outputs a multiplexer output Out_mux (coupled even and odd mode optical signals) through the port P1.

As described above, the optical interleaver 400 can be reciprocally operated between mux and demux modes. That is, in the second embodiment of the present invention, the optical interleaver 400 can be easily operated between mux demux modes without a selection unit such as a circulator.

Both in mux and demux modes, the intensity of an odd mode optical signal input or output may be decreased at the branch 413 formed due to the addition of the waveguide 411. Therefore, it is necessary to make odd and even mode optical signals have the same intensity level. For this reason, the optical amplifier (C1) 490 is added to the waveguide 411 through which an odd mode optical signal propagates, and the optical attenuator (C2) 495 is added to the waveguide 412 through which an even mode optical signal propagates. In the embodiment of FIG. 4, the optical interleaver 400 includes the optical amplifier (C1) 490 and the optical attenuator (C2) 495. However, the optical interleaver 400 may include only one of the optical amplifier (C1) 490 and the optical attenuator (C2) 495, for removing the above-mentioned signal intensity difference caused by the branch 413.

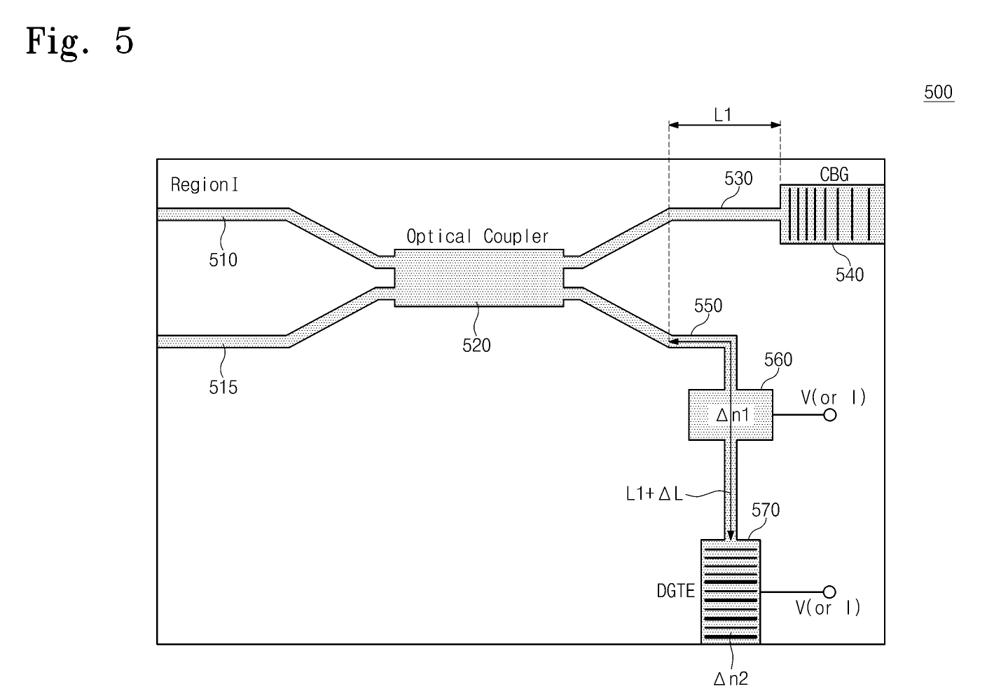

FIG. 5 is a plan view illustrating an optical interleaver 500 according to a third embodiment of the present invention. In the third embodiment shown in FIG. 5, instead of the high reflection mirrors used in the first and second embodiments, a chirped Bragg grating (CBG) is used to provide an optical path difference 2ΔL for separated optical signals.

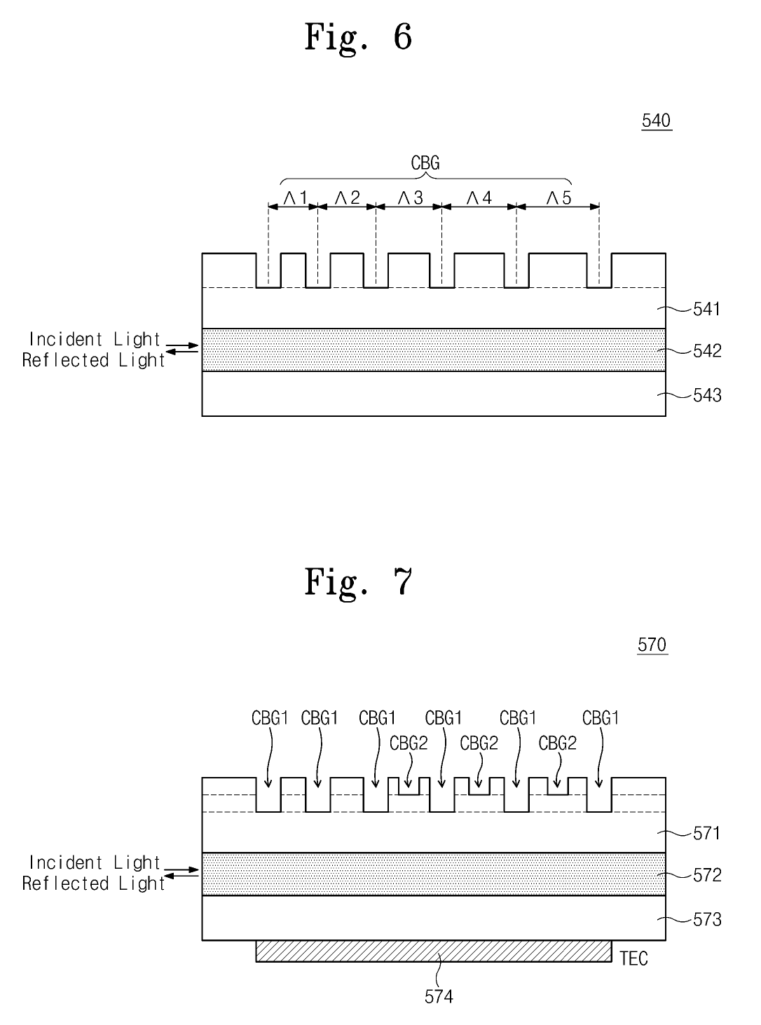

An optical signal input through a waveguide 510 is divided at an optical coupler 520 into two waveguides 530 and 550 with a predetermined optical path difference. One of the divided optical signals is incident onto a CBG part 540 through the waveguide 530. The CBG part 540 has a Bragg grating period Λ which gradually increases or decreases in the length direction of the CBG part 540. At the CBG part 540, the width of a waveguide is uniform in the length direction of the CBG part 540. The optical signal incident onto the CBG part 540 can be totally reflected according to the grating structure of the CBG part 540. In the current embodiment, the optical signal is totally reflected back to the optical coupler 520 from the CBG part 540. That is, the CBG part 540 has the same function as the high reflection mirrors of the first and second embodiments. The CBG part 540 will be described later in more detail with reference to FIG. 6.

The other optical signal divided at the optical coupler 520 and transmitted to the waveguide 550 is incident onto a second phase shifter 570 through a first phase shifter 560. A predetermined refractive index variation Δn1 can be obtained by adjusting an electric field applied to the first phase shifter 560. The second phase shifter 570 has an overlapped CBG structure, and the refractive index of the second phase shifter 570 can be varied by a refractive index variation Δn2 by adjusting the temperature of the second phase shifter 570 using an electric signal. The second phase shifter 570 may include a temperature adjustment unit for varying its refractive index by a refractive index variation Δn2. The other optical signal is reflected back to the optical coupler 520 from the second phase shifter 570 with an optical path difference corresponding to the refractive index variations Δn1 and Δn2 of the first and second phase shifters 560 and 570. The second phase shifter 570 may have a distribution Gires-Tournois etalon (DGTE) structure.

The first phase shifter 560, and an optical amplifier and an optical attenuator provided for signal reciprocity may have the same structures as those illustrated in the first and second embodiments. Therefore, descriptions of the same elements will be omitted.

FIG. 6 is a schematic sectional view illustrating the CBG part 540 of FIG. 5. Referring to FIG. 6, the CBG part 540 is configured as a high reflection mirror. A Bragg grating is useful for selective reflection or diffraction in a narrow wavelength band. Bragg gratings of various shapes and structures are used in various fields for devices such as filters, resonators, couplers, diffraction devices, sensors, optical pulse compressors, and dispersion compensators. Particularly, Bragg gratings are easily formed in waveguide shapes. Referring to FIG. 6, the CBG part 540 is formed at a waveguide to constitute an optical interleaver having a PLC structure. Grating periods Λ₁, Λ₂, Λ₃, Λ₄, and Λ₅ of the CBG part 540 gradually increase or decrease in the length direction of the CBG part 540. The CBG part 540 includes a Bragg grating region 541, a linear waveguide region 542, and a clad region 543. The Bragg grating region 541 includes a CBG having a gradually decreasing or increasing grating period. Through the linear waveguide region 542, light reflected by the CBG propagates in a reverse direction. The clad region 543 is disposed under the linear waveguide region 542. The linear waveguide region 542 may have a uniform width in the length direction of the CBG part 540.

Since the grating period of the CBG is varied in the length direction of the CBG part 540, different wavelengths of light are reflected along the length of the CBG, such that characteristics of the CBG such as a reflection wavelength band and a group delay spectrum can be adjusted. In the case of using the thermo-optic effect of the CBG, the reflection wavelength band and group delay spectrum can be modulated in various ways. By using the above-explained characteristics, the CBG part 540 can be configured as a high reflection mirror capable of reflecting incident light totally. The number of ridges of the CBG is not limited to that shown in FIG. 6.

FIG. 7 is a section view illustrating the second phase shifter 570 of FIG. 5. Referring to FIG. 7, the second phase shifter 570 includes a first Bragg grating CBG1 and a second Bragg grating CBG2. The second Bragg grating CBG2 may be overlapped with or separated from the first Bragg grating CBG1. The grating periods of the first and second Bragg gratings CBG1 and CBG2 are gradually increased. However, the present invention is not limited thereto. That is, the grating periods of the first and second Bragg gratings CBG1 and CBG2 may be gradually decreased. The second phase shifter 570 includes a CBG layer 571, a linear waveguide region 572, and a clad region 573. The first and second Bragg gratings CBG1 and CBG2 are formed at the CBG layer 571. Light reflected from the first and second Bragg gratings CBG1 and CBG2 is propagated in a reverse direction through the linear waveguide region 572. The clad region 573 is disposed under the linear waveguide region 572. The second phase shifter 570 further includes a TEC region 574 for varying the refractive index of the second phase shifter 570.

According to the above-described structure, incident light is reflected by the first Bragg grating CBG1 and the Bragg gratings CBG1 and CBG2. Therefore, the effect of a Fabry-Perot filter can be obtained according to interference between light reflected by the first Bragg grating CBG1 and the Bragg gratings CBG1 and CBG2. Therefore, the second phase shifter 570 can vary an interference pattern of incident and reflected light at the optical coupler 520.

According to the structures shown in FIGS. 6 and 7, the second phase shifter 570 may be formed of one of materials used for forming waveguides. In a region I, the CBG is formed instead of a high reflection mirror, and in a region II, a GT mirror structure is provided in the form of a DGTE by forming the Bragg gratings CBG1 and CBG2 in an overlapped or separated manner. In addition, the phase of reflected light can be adjusted by varying the temperature of the DGTE structure using a TEC. Therefore, the center wavelength of the optical interleaver 500 can be finely adjusted by varying the refractive index of the second phase shifter 570. In the current embodiment, the TEC region 574 is used to vary the refractive index of the second phase shifter 570 by a refractive index variation Δn2. However, other methods or structures can be used to vary the refractive index of the second phase shifter 570 by a refractive index variation Δn2.

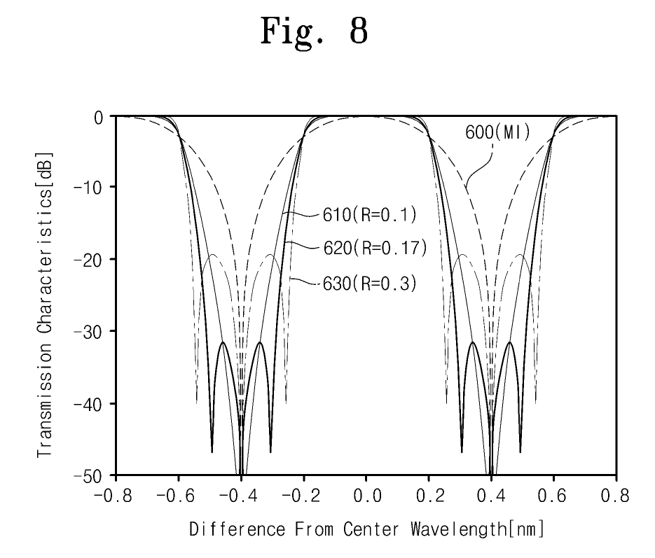

FIG. 8 is a graph showing transmission characteristics of an optical interleaver according to an embodiment of the present invention. FIG. 8 shows transmission characteristics of an optical interleaver having the above-described silica PLC structure, with respect to wavelength difference from the center wavelength of the optical interleaver.

The transmission characteristics were measured from a free spectral range (FSR) optical interleaver having 50-GHz wavelength spacing (0.4 nm) under the following test conditions: refractive index of region I n1=1.46, and refractive index of region II n2=1.46. The center wavelength of the optical interleaver was set to 193.1 THz, and GT mirror spacing was set to about 2 mm based on the equation: d=c/(2n2×FSR). An optical path difference ΔL was set to about 1 mm based on the equation: n1×ΔL=0.5×d×n2. A dashed curve 600 exhibits the characteristic of a Michelson interferometer (MI) having a reflection index R=0, and a more exact flat-top curve can be obtained by increasing the reflection index R of a reflection surface formed between regions I and II. That is, a characteristic curve 630 (R=0.3) exhibits better optical signal transmission characteristics than lower reflection index characteristic curves 610 and 620. In other words, the transmission characteristic curve of an optical signal having a 193.1-THz center wavelength can be further flattened.

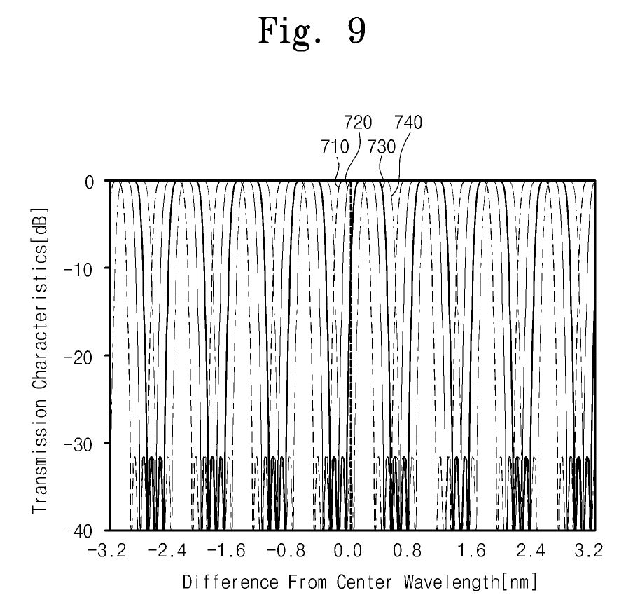

FIG. 9 is a graph showing tuning characteristics of an optical interleaver according to an embodiment of the present invention. FIG. 9 shows wavelength variation characteristics of an optical interleaver for different refractive index variations Δn2 of a second phase shifter (270, 370, 470, or 570) obtained by varying an electric field applied to the second phase shifter.

An electric field applied to the second phase shifter (270, 370, 470, or 570) was varied to obtained refractive index variations Δn2=0, 1×10⁻⁴, 2×10⁻⁴, and 3×10⁻⁴. In detail, a characteristic curve 710 shows tuning characteristics in the case where the refractive index variation Δn2 of the second phase shifter (270, 370, 470, or 570) is near zero. A characteristic curve 720 shows tuning characteristics in the case where the refractive index variation Δn2 of the second phase shifter (270, 370, 470, or 570) is about 1×10⁻⁴. A characteristic curve 730 shows tuning characteristics in the case where the refractive index variation Δn2 of the second phase shifter (270, 370, 470, or 570) is about 2×10⁻⁴. A characteristic curve 740 shows tuning characteristics in the case where the refractive index variation Δn2 of the second phase shifter (270, 370, 470, or 570) is about 3×10⁻⁴. A refractive index variation Δn1 was adjusted according to the refractive index variation Δn2 to satisfy the equation of Δn1×h=0.5×d×Δn2. According to the equation, when the length of a first phase shifter is h>0.5d, the refractive index variation Δn1 is smaller than the refractive index variation Δn2 (Δn1<Δn2), and when the refractive index variation Δn2 is about 5×10⁻⁴, a wavelength variation of about 0.2 nm (25 GHz) can be obtained. In the case of a silica structure of which the refractive index varies little with temperature, the refractive index variation of 5×10⁻⁴ may be obtained by varying the temperature of the silica structure by 7□.

As explained with reference to FIG. 9, according to the present invention, the center wavelength (or center frequency) of the optical interleaver can be finely adjusted by applying an electric signal to the optical interleaver. Therefore, the optical interleaver can be highly compatible with other devices, particularly, components of a WDM-PON system.

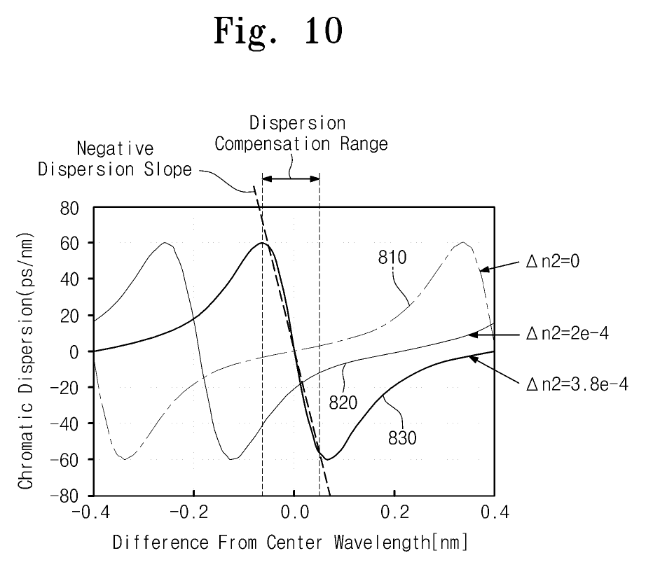

FIG. 10 shows chromatic dispersion characteristic of an optical interleaver having a reflection index R=0.17 and 100-GHz channel spacing, for different refractive index variations Δn2. When the refractive index variation Δn2 of the optical interleaver was 3.8×10⁻⁴, a dispersion curve 830 having a negatively sloped section was obtained. The optical interleaver can be used as a dispersion compensator by using the negatively sloped section of the dispersion curve 830. Particularly, when the optical interleaver of the present invention is used as a dispersion compensator of a WDM system having 50-GHz channel spacing, stable and precise wavelength tuning is possible. A linear dispersion slope and a wide compensation range that are obtained by refractive index tuning can be optimized by varying structural variables and using a structure such as a GT mirror.

As described above, the optical interleaver of the present invention can be provided in the form of a PLC single chip structure, so that costs necessary for two or three dimensional alignment in a bulk structure can be saved. In addition, the optical interleaver is relatively small as compared with a bulk-optics or optical fiber interleaver, and thus, according to the present invention, inexpensive, low-loss, and highly-reliable interleaver products can be provided by mass production. Furthermore, the refractive index of the optical interleaver can be tuned without mechanical adjustment by using wavelength tuning units (the first and second phase shifters). Therefore, optical path difference tuning and wavelength tuning are reliably carried out for improving the reliability of the optical interleaver.

According to the embodiments of the present invention, a Michelson interferometer (MI) and a Gires-Tournois (GT) mirror, which are constituted using an optical coupler, a branch waveguide, and a reflection mirror, are disposed on a single chip to form a wavelength tunable optical interleaver (or de-interleaver). Therefore, the wavelength tunable optical interleaver (or de-interleaver) can have a small size. In addition, since optical alignment between separate components is not necessary, the wavelength tunable optical interleaver (or de-interleaver) can be reliably operated. Furthermore, wavelength tuning of the wavelength tunable optical interleaver (or de-interleaver) is possible by using an electric signal without mechanical adjustment. Therefore, the wavelength tunable optical interleaver (or de-interleaver) can be structurally stable and inexpensive, and thus applicable in various fields.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An optical interleaver comprising:
an optical coupler configured to divide an input optical signal;
a first waveguide branching off and extending from the optical coupler in a first direction;
a second waveguide branching off from the optical coupler in a second direction for providing an optical path different from an optical path provided by the first waveguide;
a high reflection mirror disposed at an end of the first waveguide for reflecting a first optical signal incident onto the first waveguide;
a first phase shifter disposed at an end of the second waveguide for multiple reflection of a second optical signal incident onto the second waveguide; and
a second phase shifter disposed at the first waveguide or the second waveguide for adjusting an optical path difference between the first and second waveguides by varying a refractive index of the second phase shifter.

2. The optical interleaver of claim 1, wherein the first phase shifter comprises:
a first reflection surface configured to transmit or reflect the second optical signal separated from the input optical signal;
a second reflection surface configured to reflect the second optical signal reflected by the first reflection surface; and
a refractive index variable medium disposed between the first and second reflection surfaces.

3. The optical interleaver of claim 2, wherein the refractive index variable medium has a refractive index variable by an electric signal.

4. The optical interleaver of claim 1, wherein the refractive index of the second phase shifter is variable by an electric signal.

5. The optical interleaver of claim 1, further comprising:
a third waveguide configured to transmit the input optical signal to the optical coupler and output a first demultiplexer signal separated by the optical coupler in a demultiplexer mode; and
a fourth waveguide configured to output a second demultiplexer signal separated by the optical coupler in the demultiplexer mode.

6. The optical interleaver of claim 5, wherein in a multiplexer mode, the third and fourth waveguides receive first and second multiplexer signals, respectively, and the third waveguide receives a third multiplexer signal in which the first and second multiplexer signals are combined from the optical coupler and outputs the third multiplexer signal.

7. The optical interleaver of claim 6, further comprising:
a fifth waveguide connected to the third waveguide for receiving the input optical signal in the demultiplexer mode and outputting the third multiplexer signal in the multiplexer mode; and
a sixth waveguide connected to the third waveguide for outputting the first demultiplexer signal in the demultiplexer mode and transmitting the first multiplexer signal to the third waveguide in the multiplexer mode.

8. The optical interleaver of claim 7, further comprising an optical amplifier disposed at the sixth waveguide for amplifying the first multiplexer signal or the first demultiplexer signal.

9. The optical interleaver of claim 8, further comprising an optical attenuator disposed at the fourth waveguide for attenuating the second multiplexer signal or the second demultiplexer signal.

10. The optical interleaver of claim 1, wherein the high reflection mirror has the same structure as that of the first phase shifter and operates as a GT (Gires-Tournois) mirror.

11. The optical interleaver of claim 1, wherein the high reflection mirror is a CBG (chirped Bragg grating) disposed at the end of the first waveguide.

12. The optical interleaver of claim 1, wherein the first phase shifter comprises a plurality of CBGs disposed at the end of the second waveguide and having different grating periods.

13. The optical interleaver of claim 12, wherein the first phase shifter is a DGTE (dispersion Gires-Tournois etalon) in which the CBGs are overlapped with each other.

14. The optical interleaver of claim 12, wherein the first phase shifter further comprises a refractive index tuning unit disposed at a lower side of the CBGs for varying a refractive index of an extension part of the second waveguide.

15. The optical interleaver of claim 14, wherein the refractive index tuning unit comprises a TEC (thermo-electric cooler) of which temperature is externally controllable.

16. The optical interleaver of claim 1, wherein the optical coupler, the first waveguide, the second waveguide, the high reflection mirror, the first phase shifter, and the second phase shifter are disposed at a single chip in a PLC (planar lightwave circuit) structure.

17. The optical interleaver of claim 16, wherein the first and second waveguides are formed of at least one of silica, polymer, compound semiconductor (InGaAs/InP).

18. The optical interleaver of claim 1, wherein the input optical signal is compensated for dispersion by controlling refractive indexes of the first and second phase shifters.
